(19) United States
(12) Patent Application Publication
(10) Pub. No.: US 2009/0201966 A1
(43) Pub. Date: Aug. 13, 2009

(54) Process for a mission of pulsed laser radiation and associated laser source

(75) Inventors: Antoine Hirth, Niffer (FR); Christelle Kieleck, Saint-Louis (FR)

Correspondence Address: OLIFF & BERRIDGE, PLC, P.O. BOX 320850, ALEXANDRIA, VA, 22320-4850, US

(73) Assignee: INSTITUT FRANCO-ALLEMAND DE RECHERCHES DE SAINT-LOUIS, SAINT-LOUIS (FR)

(21) Appl. No.: 12/320,099

(22) Filed: Jan. 16, 2009

(30) Foreign Application Priority Data
Jan. 25, 2008 (FR) 08 00387

(51) Int. Cl. H01S 3/091

(52) U.S. Cl. 372/70

(57) ABSTRACT

The present invention especially concerns the field of lasers. Specifically, the object of the invention is a process for the emission of pulsed laser radiation generated by at least one laser crystal which is located in a cavity containing a first and a second mirror and pumped by des pumping means, wherein said process includes a first stage which consists of generating a first pumping laser radiation with an intensity of J_{c} which is capable of bringing the crystal at least to the laser emission threshold and a second stage which consists of generating a second pumping laser radiation with an intensity of Jₚ in the form of a step, whereby said second radiation is superimposed, at least in part, on said first radiation or immediately succeeds it, and whereby the intensity Jₚ, in the latter case, is greater than the intensity J_{c} of said first radiation, as well as a laser source capable of activating said process.

The invention especially concerns the field of lasers. Specifically, the object of the invention is a process for the emission of pulsed laser radiation and a laser source capable of functioning in low-frequency pulsed mode, of the type which includes a crystal located in a laser cavity and pumping means which are capable of generating pulsed radiation in the direction of said crystal.

The solid pulsed laser sources with high pulsed energy, at a low pulse frequency (<100 Hz), emitting on the order of 1 μm (Nd or Yb), are known from prior art. For optical pumping, pulsed diodes have proven to be very effective for operation in both normal pulse mode and Q-switched mode. For Nd:YAG, for example, in normal pulse mode, with 200 μs pumping duration, the duration of the emission is practically identical to that of the pumping. At low frequency (frequency <<ζ, ζ life span of upper level), on each firing, after a transitory of a few ps up to 10 μs, according to the pumping level, the emission of years and follows the pumping profile and the pulsed energy of the pump diode is effectively transformed into laser energy.

An entirely different situation prevails for doped Tm, Ho or Er materials emitting on the order of 2 or 3 μm. At low frequency, the conversion yield of the pulsed pumping energy Eₚ into laser energy E_{L} is quite inferior to that obtained in continuous or high-frequency mode (>1 kHz).

For example, for Ho:YAG pumped at 1.91 μm in continuous mode (CW), the total yield obtained is greater than 50%; it can reach more than 80% in high-frequency pulsed mode, that is, with a frequency greater than 1 kHz. On the other hand, in low-frequency pulsed mode (60 Hz) with 5 ms pumping pulse duration, the yield obtained is less than 30%, as indicated, for example, in the document by Budni et al. entitled “Q-switched, 2.09-μm holmium laser resonantly pumped by a diode-pumped 1.9-μm thulium laser”.

There is a great interest in ocular-safe 2 and 3 μm laser sources, which, on one hand, show a high level of efficacy in CW mode when the material is directly pumped by diodes and, on the other hand, provide access to medium infrared (IR). Thus, starting with a laser wavelength of 2 μm, a single optical parametric oscillator (OPO) is sufficient for obtaining a wavelength in the II band. But at very low frequency, in bursts, and especially in single firing, the energy yield drops drastically, and the laser energies of successive pulses vary. For certain applications, especially military, such as optronic counter-measures (OCM), burst mode assumes great importance.

In order to fight against first-generation missile homing heads, the jamming of the signals generated by the reticle device may be sufficient if, by means of a smart loop, the high frequency or CW mode system is capable of generating appropriate pulse sequences. For more recent-generation homing heads, the only solution consists of damaging the detectors used for guidance.

As the time available for handling the threat is limited, the OCM source need only provide a limited series of pulses during a fraction of a second or up to a plurality of second. The resultant advantages for the system include reduction of average electrical power consumption, reduced weight and reduced overall dimensions. However, new problems also arise:
the source must be ready at any moment,
all of the pulses within the limited series must be effective, starting from the initial triggering of the burst.

In spite of the difficulties set forth above, which are inherent to low-frequency pulsed 2 or 3 μm sources, relative to 1 μm sources (Nd or Yb), there is still preferred, due to their effectiveness in going into the medium IR range with the help of a single OPO.

The objective of the invention is to resolve the difficulties set forth above while proposing a solution which makes it possible, on one hand, to increase the effectiveness of low-frequency pulsed 2 μm sources, and especially those operating in burst mode, while raising the yield of the conversion from pulsed pumping energy to laser energy and thereby reducing the weight and overall dimensions of the source, and, on the other hand, to benefit from this increased yield in order to reduce the portion of the energy transformed into heat in the lasant and to diminish the thermal lens effects so as to obtain, with the geometry of the laser rod, the best spatial profile of the beam emitted (M² as low as possible).

The proposed solution is, on one hand, a process for the emission of pulsed laser radiation generated by at least one laser crystal which is located in a cavity consisting of a first mirror and a second mirror and pumped by pumping means, wherein said process includes a first stage which consists of generating a first pumping laser radiation with an intensity of J_{C} which is capable of bringing the crystal at least to the laser emission threshold and a second stage which consists of generating a second pumping laser radiation with an intensity of J_{P} in the form of a step, whereby said second radiation is superimposed, at least in part, on said first radiation or immediately succeeds it, and whereby the intensity J_{P}, in the latter case, is greater than the intensity J_{C} of said first radiation.

The word “immediately” should be understood as meaning that the time which separates them should not bring the crystal below its laser emission threshold.

Thus, a continuous, permanent auxiliary pumping precedes or is superimposed upon the principal pulsed optical pumping, so as to keep the laser environment in a state of population inversion which corresponds to the threshold. Accordingly, the source is kept ready to operate at maximum efficiency starting from the first firing.

According to a particular embodiment, a laser emission process according to the invention is a process wherein the second stage consists of superimposing a second pumping laser radiation with an intensity of J_{P} in the form of a step on the first radiation.

According to another characteristic, the first and second radiations have different wavelengths.

The invention also concerns a laser source which is capable of generating laser pulses, which includes pumping means which are capable of pumping a laser crystal located within a cavity delimited by a first and a second mirror, the pumping means being capable of generating a pumping laser radiation with an intensity of J_{P} in the form of a step, wherein the pumping means are capable of generating a first pumping laser radiation with an intensity of J_{C} which is capable of bringing the crystal at least to the laser emission threshold and a second stage which consists of generating a second pumping laser radiation with an intensity of J_{P} in the form of a step, whereby said second radiation is superimposed, at least in part, on said first radiation or immediately succeeds it, and whereby the intensity J_{P}, in the latter case, is greater than the intensity J_{C} of said first radiation.

According to another characteristic, the pumping means include first auxiliary pumping means which are capable of generating the first radiation and second principal pumping means which are capable of generating said second pumping radiation in the form of a step.

According to a particular characteristic, a source according to the invention includes at least one of the following characteristics:
the first pumping means are capable of generating a first continuous pumping laser radiation,
the pumping means include at least one laser diode,
the first and second pumping means are capable of generating first and second pumping laser radiations with different wavelengths,
the crystal includes at least three faces, and wherein the pumping means include first and second pumping means capable of generating said first and second pumping radiations in the direction of a first face of said crystal and at least third pumping means capable of generating at least a third of pumping radiation in the direction of a second face of said crystal,
a beam splitter which includes at least one principal face covered by a reflective coating which reflects at the wavelength or wavelengths of the pumping radiations and is transparent for a polarization of the laser radiation generated by the crystal, is located in the interior of the cavity and is capable of directing said at least third laser radiation in the direction of said second face of the crystal,
the cavity includes a plurality of laser crystals, each crystal having, for example, the shape of a rod,
the cavity includes a plurality of assemblies composed of a crystal and a beam splitter, whereby the latter includes at least one principal face covered by a reflective coating which reflects at the wavelength or wavelengths of the pumping radiations and is transparent for a polarization of the laser radiation generated by the crystal,
the crystal consists of one of the following crystals: YAG, YALO, YVO4 or YLF doped with thulium or holmium.
   For example, a crystal in the form of a cylindrical rod includes three faces, whereas a cube has six.

In order to obtain the best spatial profile, a rod geometry and a pumping spectrum range are chosen which reduces, as far as possible, the thermal load per unit of volume and the associated mechanical stress.

Moreover, if the crystal consists of Tm:YAG, the pumping is performed on a secondary absorption peak (805 nm for Tm:YAG instead of 785.6 nm corresponding to maximum absorption) (wing pumping), leading to the use of rather long rods in the case of coaxial pumping.

The rod geometry must be as close as possible to that of a fiber laser. Thanks to “wing pumping”, the lasant becomes long, and the diameter of the rod is reduced to the minimum, so as to be able to hold the laser flow and to correspond, for a given resonant cavity, to the extension of the basic transverse mode (diameter from 1.5 to 3 mm, in a cavity from 20 to 50 cm).

The spectroscopic parameters, especially the effective sections of weak absorption and emission and the lifespan of the upper laser level (about 10 ms), in the low-frequency pulsed or single-pulse mode, show a considerable difference between the duration of the laser emission and that of the pumping. In the state of the art, the need to almost entirely renew the population inversion leads to a considerable reduction of the yield.

When the frequency increases, successive firings leave behind them, when falling below the emission threshold, a not inconsiderable part of the inversion at the end of the pumping pulse, for which the following firings benefit.

Preferably, the rod or the rods are close to 100 mm long, with a polished lateral surface, and are immersed in a cooling liquid with a weaker index, so as to act like waveguides for the pumping light and the laser beam. By attempting to attain the best ratio between exchange surface and volume, the thermal lens effects can be reduced. The resulting important increase in the length of the lasant will allow the power of the continuous pumping so as to be reduced to the minimum.

Other advantages and characteristics of the present invention will appear in the description of various embodiments of the invention, which relates to the attached figures, where:

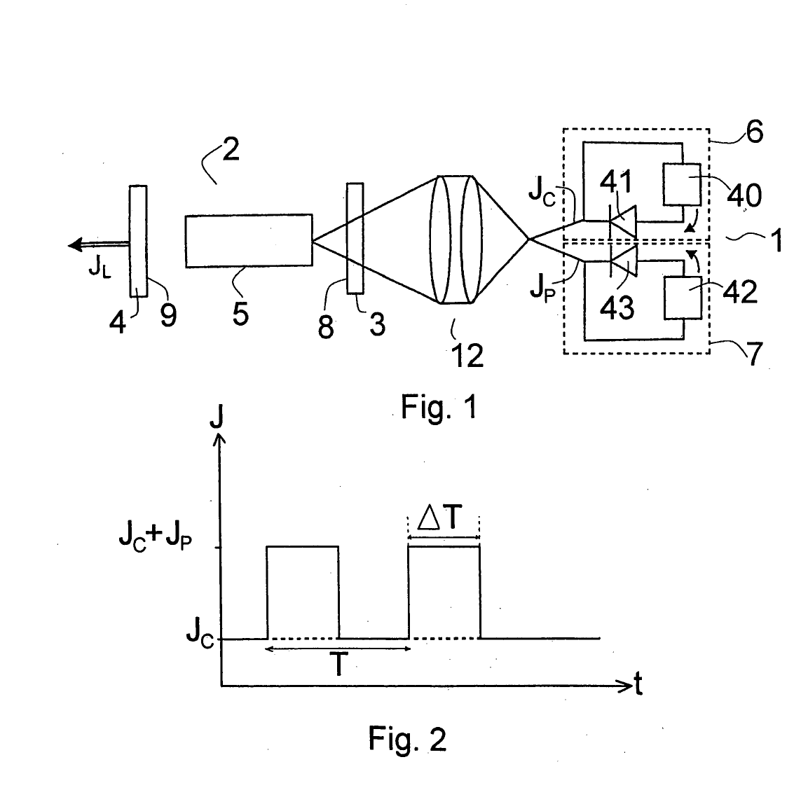

FIG. 1 shows a schematic diagram of a laser source according to a first embodiment of the invention.

FIG. 2 shows a schematic diagram of the superimposition of the first and second laser radiations respectively generated by first and second pumping means.

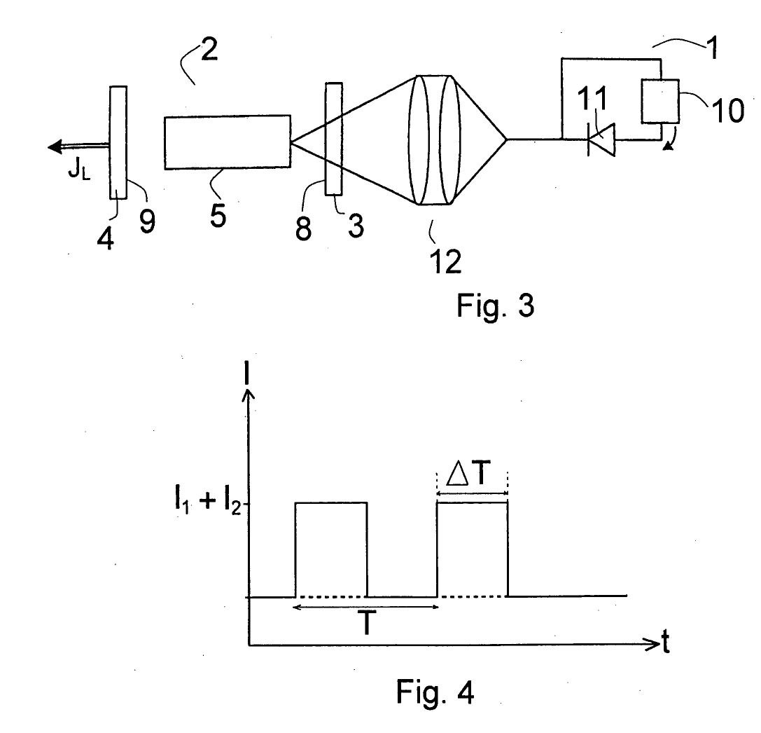

FIG. 3 presents a schematic diagram of one embodiment of the pumping means of a source according to this embodiment of the invention.

FIG. 4 shows a schematic diagram of the intensity I generated by an electrical generator as a function of time and in view of the obtaining of said first and second laser radiations.

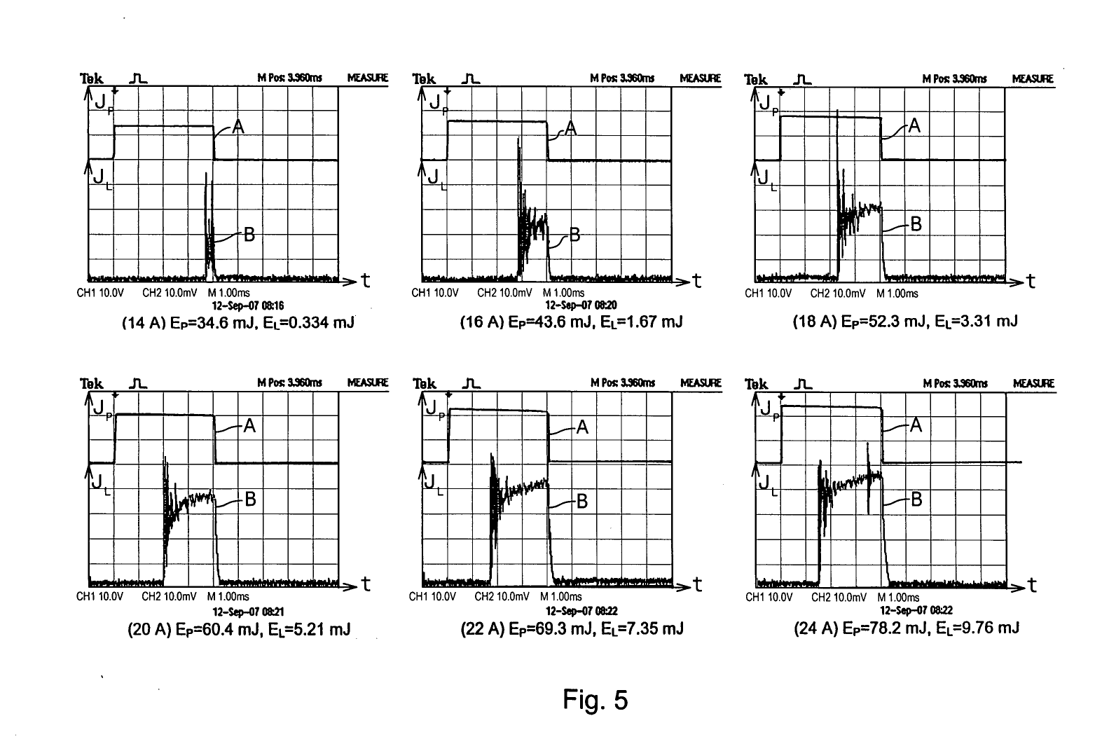

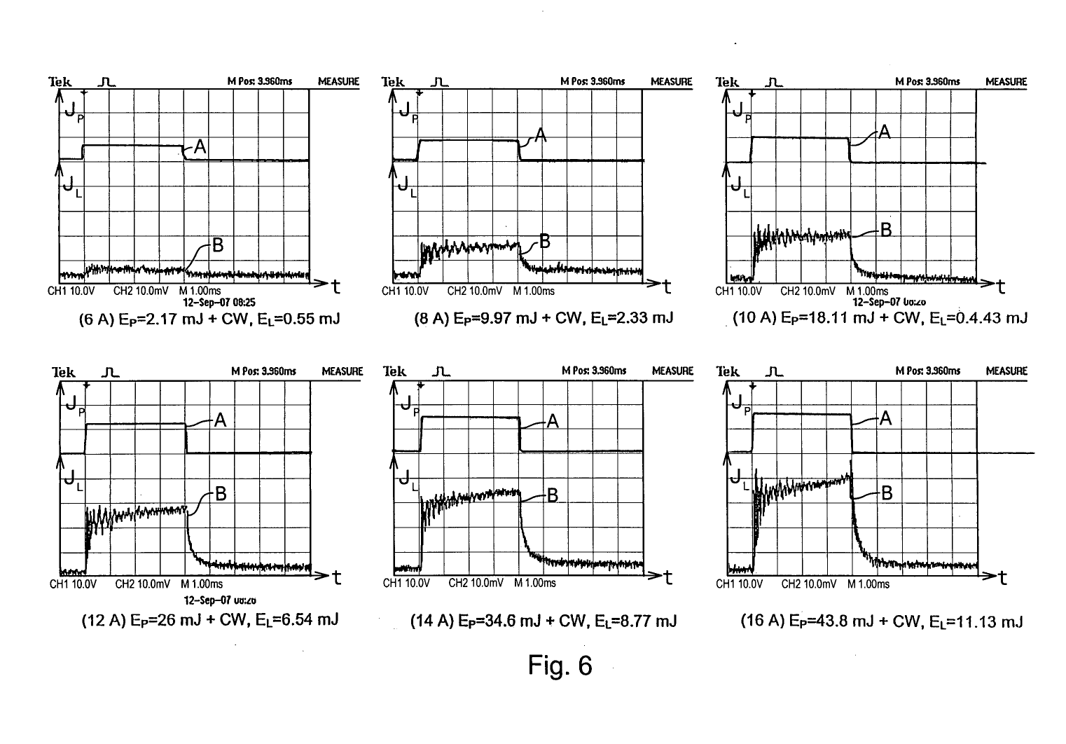

FIGS. 5 and 6 present, as a function of time t, the development of the intensity J_{L} of the laser radiation generated by the source as a function of the intensity of a pumping radiation constituted by a step, and respectively, with a source known from prior art and with a source according to the invention.

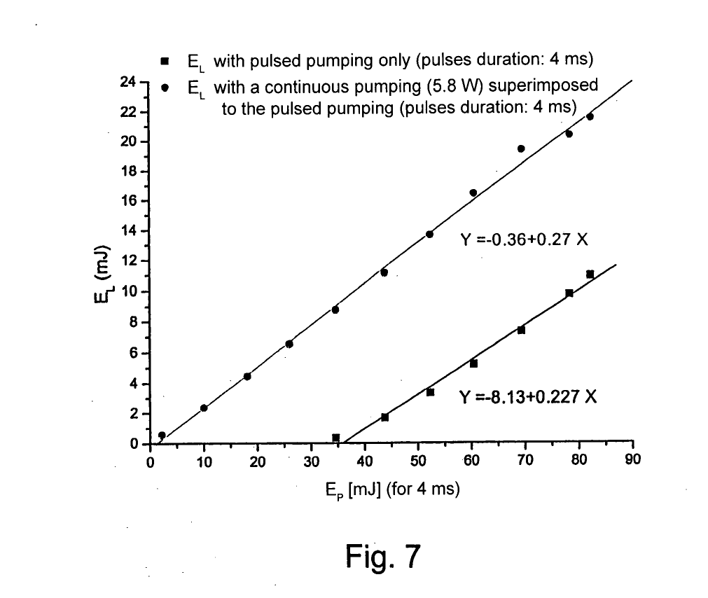

FIG. 7 shows the energy EL generated by the crystal as a function of the energy provided by the step, respectively with a device known from prior art (curve A) and with a device according to FIG. 3 (curve B).

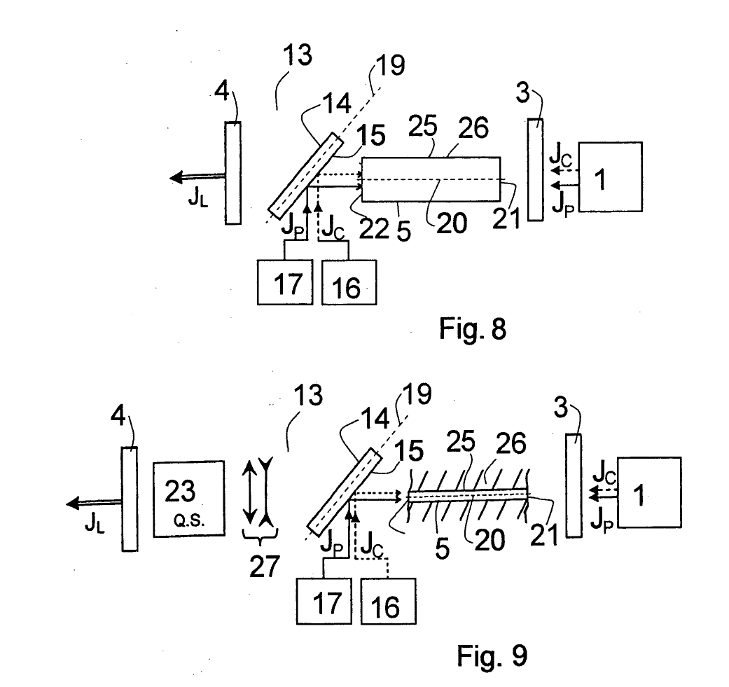

FIG. 8 shows a schematic diagram of a laser source according to a second embodiment of the invention.

FIG. 9 shows a schematic diagram of an embodiment of FIG. 8 in which a shutter and a beam expander have been added.

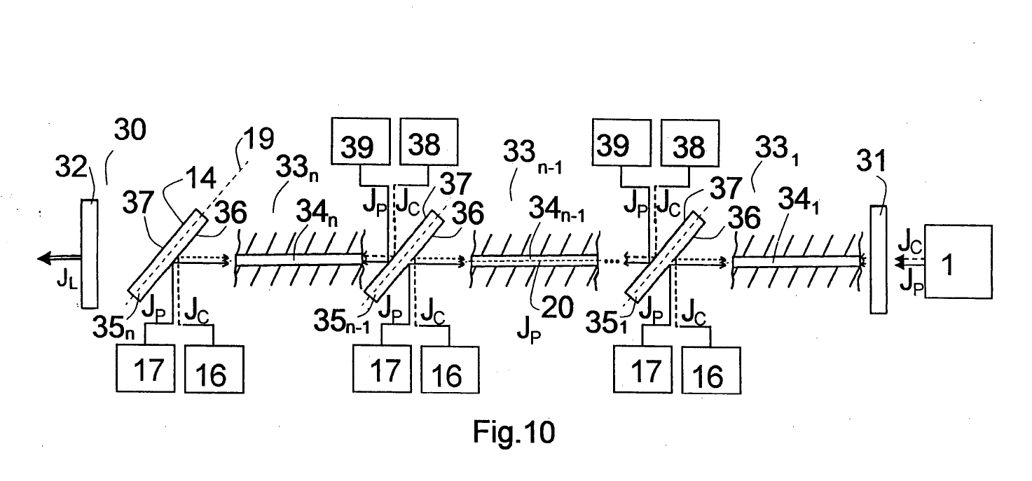

FIG. 10 presents a third embodiment of the invention.

FIG. 1 shows a laser source according to a first embodiment of the invention which includes:
a laser cavity 2 delimited by a first and a second mirrors, respectively 3 and 4, inside which is located a crystal 5 capable of generating a laser radiation,
pumping means 1 constituted by first and second pumping means 6 and 7 which are located outside the cavity and are capable of generating a first and a second laser radiations respectively.

Within the laser cavity, the first mirror 3, which is located beside the first and second pumping means 6 and 7, includes a coating 8 inside the cavity, which is transparent at the wavelength of said first and second laser radiations and reflects at the wavelength of the laser radiation generated by the crystal.

The second mirror 4 of the cavity 2, which is the exit mirror, includes a coating 9, inside the cavity, which is transparent at the wavelength of the laser radiation generated by the crystal and reflects at the wavelength of said first and second laser radiations, in the case where all of the pumping radiation is not absorbed by the crystal.

The first laser pumping means 6, called auxiliary means, are capable of generating a continuous radiation at a first pumping wavelength of said laser crystal 5. These first laser pumping means 6 are capable of keeping the laser crystal 5 in a state of population inversion corresponding to the laser emission special. The second laser pumping means, called principal means, are capable of generating a pulsed radiation at a second pumping wavelength of said laser crystal 5. In this embodiment of the invention, the first and second pumping wavelengths are identical and the crystal is formed by a rod.

This rod 5, placed in the cavity 2 delimited by the two mirrors 3 and 4, is optically pumped, on one hand, by the first pumping radiation generated by the first pumping means 6, whereby said radiation, as shown in FIG. 2, has a continuous component with an intensity of J_{c} and, on the other hand, by a second pulsed pumping radiation generated by the second pumping means 7 and which attains an intensity of J_{P} during a duration of ΔT , which repeats with a periodicity of

$$T ( duty cycle ) \frac{Δ T}{T} )$$

and which is superimposed on the first radiation.

In this embodiment, the first pumping means 6 are composed of a first electrical power source 40 and by a weak diode—specifically, with a power on the order of 1 to 10 W, the necessary power being a function of the crystal dimensions and the repetition frequency, whereby the necessary power increases as the frequency decreases and the crystal has a considerable volume, whereas the second pumping means 7 are composed in the second electrical power source 42 and by a strong diode, a strip of strong diodes or a two-dimensional matrix of strong diodes 43, whereby the power may be as high as a plurality of hundred watts.

A collimating/focusing optical device 12 is located between the pumping means 1 and the cavity 2, in order to focus the pumping laser radiations in the direction of one of the faces of the crystal 5.

FIG. 2 presents the superimposition of the first and second pumping laser radiations generated by the first and second pumping means 6, 7. The first radiation is continuous with an intensity of J_{C} whereas the second is pulsed in the form of a step, with an intensity equal to J_{P}, the pulse durations being equal to ΔT and the period to T.

FIG. 3 presents a schematic diagram of an embodiment of the pumping means of a source according to this embodiment of the invention.

The cavity is identical to that presented in FIG. 1.

The pumping means 1 are composed of a single electrical generator 10 electrically connected to at least one diode or a strip of diodes or a two-dimensional matrix of diodes 11 capable of generating a radiation at a pumping wavelength of the crystal 5.

The electrical generator 10 is capable of generating, as shown in FIG. 4, an intensity I as a function of time, in the form of a window with a duration of AT and a periodicity of T, the intensity 12, between two successive windows being different from 0,and capable of generating, via the diode 11, a pumping laser radiation with an intensity of J_{C} whereas the windows with an intensity of I1 are capable of generating via the diode 11 a pumping laser radiation with an intensity of J_{P}. Thus, with the help of an associated diode 11, the generator 10 is capable, by shaping the current which generates, of reproducing the necessary time profile of the pumping intensity. A collimating/focusing optical device 12 enables the coupling of the pumping radiation intensity in the rod 5 in order to generate the laser intensity J_{L} at the exit of the cavity 2.

FIGS. 5 and 6 show, as a function of time t, the development of the intensity J_{L} of the laser radiation generated by the source as a function of the intensity J_{P} of a pumping radiation composed of a step, for six different pumping intensities and for a step window duration of 4 ms and respectively, with a source known from prior art, that is, without generation of a continuous pumping radiation with an intensity of J_{C} before the step, and with a source according to the invention, that is, with generation of a continuous pumping radiation with an intensity of J_{C} before the step. Curves A and B synchronously represent, respectively, the intensity of pumping radiation consisting of a step and the intensity of the laser pulse generated by the source.

In FIG. 5, using a device known from prior art, the intensity E_{P} of the pumping radiation of the step is between 34.6 and 78.2 mJ, whereas the intensity E_{L} of the laser radiation leaving the cavity is between 0.334 and 9.76 mJ. At the level of the laser pulse with an energy of E_{L} generated by the crystal, we note a phenomenon of oscillation/relaxation, which is also known by the name of spiking. The weaker the pumping energy, the later the generated laser pulse begins, relative to the start of the step. As may be seen in FIG. 7, which shows the energy E_{L} generated by the crystal as a function of the energy provided by the step, respectively with a device known from prior art (curve A) and with a device according to FIG. 3 (curve B). In the case of the curve A, the pumping energy absorbed by the rod which is necessary for generating a laser pulse, that is, for attaining the laser emission threshold, is approximately 34.5 mJ.

In FIG. 6, using a laser source according to the embodiment of the invention shown in FIG. 3, taking into account the permanent presence of a pumping radiation with an intensity of J_{C} enabling the population inversion in the rod, the generation of a supplementary window-shaped pumping radiation, even of very weak energy, makes it possible to obtain a laser emission throughout the entire duration of the window enables considerable reduction of the oscillation/relaxation phenomenon.

As shown in FIG. 7, curve B, the laser emission generated by the rod is produced as soon as a supplementary energy is applied. Thus, by means of the triggering operation, it is possible to trigger the laser pulse at any time throughout the window, which is absolutely impossible with a device known from prior art, because it is necessary to wait for the rod to absorb the energy necessary in order to give rise to a population inversion inside the rod. In addition, it is possible, by means of simple synchronization electronics and programming only a delay in triggering, to obtain perfect reproducibility of the laser pulses generated by the source, which is absolutely not the case with a source known from prior art.

FIG. 8 shows a semantic diagram of a laser source according to a second embodiment of the invention.

Relative to that shown in FIG. 3, the cavity 13 also includes a beam splitter 14 located between the crystal 5 and the second mirror 4, and of which the plane 19 forms a 45° angle with the longitudinal axis 20 of the crystal 5. This beam splitter 14 includes a coating 15 which reflects at the pumping wavelength and transparent, for a polarization (for example, P), at the laser radiation generated by the crystal 5.

In addition, this laser source includes third and fourth pumping means 16 and 17, which are located outside of the cavity 13 and capable of generating respectively a third and a fourth pumping laser radiations, which, in this embodiment, are respectively identical to said first and second pumping laser radiations.

These third and fourth pumping means 16 and 17 are capable of generating said third and fourth pumping laser radiations in the direction de sending splitter 14 and with a 45° angle relative to the plane 19 of the beam splitter 14, so that these radiations are reflected in the direction of the crystal 5. In this embodiment; the third and fourth means 16 and 17 are identical to the pumping means 1 of the FIG. 3, that is, they consist of a generator 10 and a diode or a strip of diodes or a two-dimensional matrix of diodes 11. In any event, however, the generator may be common to the pumping means 1 and the third and fourth pumping means 16 and 17.

Thus, by operating the beam splitter 14 in the cavity 13, it is possible, for a laser crystal 5, which, for example, is in the form of a rod, to increase the length thereof, because it is possible to perform a pumping operation by means of its two lateral faces 21 and 22. The beam splitter 14 totally reflects the pumping radiation with an intensity of J_{C}+J_{P} whereas digitally transmits the laser radiation with a polarization P in the direction of the exit mirror 4.

As shown in FIG. 9, in which the laser crystal 5 is represented in the form of a rod 5, it is also possible, relative to FIG. 8, to place a shutter 23 (Q-Switch) between the beam splitter 14 and the exit mirror 4, so as to be able to switch from relaxed (normal pulsed) operating mode to Q-switched mode.

In addition, for maximum evacuation of the heat developed in the rod, and in order to increase the exchange surface of the rod relative to its volume, the rod 5, with a diameter equivalent to the diameter of the basic mode in the cavity 13, and a length corresponding to approximately twice the absorption length due to doping with active ions (about 100 nm for a 2% thulium doping in YAG and a pumping wavelength of 805 nm), is implemented with its longitudinal face 25 polished and placed in a cooling liquid 26 so as to serve as a waveguide for the pump and the laser emission. In addition, a beam expander 27 is located, relative to FIG. 8, between the beam splitter 14 and the shutter 23. This beam expander enables simultaneous reduction of the power density at the entrance to the system and correction of the thermal lens effect.

As the length of a rod is limited by the absorption coefficient of the pumping radiation for a given ion doping, the increase in length of the lasant can be implemented by placing a plurality of rods in series. FIG. 10 presents such a source. The cavity 30, in this embodiment, includes a first and a second mirror 31, 32, the second mirror 32 being the exit mirror of the cavity 30. Located between the first and the second mirrors 31, 32 are a plurality of successive assemblies 33₁ through 33ₙ, each consisting of a rod 34 and a beam splitter 35 and only three of which are shown. Each of these splitters 35₁ through 35ₙ is inclined at a 45° angle relative to the longitudinal axis 20 of the rod or rods associated with it and includes, on each of its first and second principal faces 36, 37, a coating 15 which reflect that the pumping wavelength and transparent, for a polarization (for example, P), at the laser radiation generated by the crystal. It should be noted that the last splitter 35ₙ may not have a coating on the exit mirror site, because it does not face a rod.

Associated with each of the assemblies 33ᵢ, except for said last splitter 35ₙ, are, on one hand, the third and fourth pumping means 16 and 17 capable of generating said third and fourth pumping laser radiations in the direction of said first principal face 36 of beam splitter 35ᵢ and with a 45° angle relative to the plane 19 of said splitter, so that these radiations are reflected in the direction of the associated rod 34ᵢ of the same assembly as the beam splitter in question and, on the other hand, fifth and sixth pumping means 38 and 39 capable of generating fifth and sixth pumping laser radiations in the direction of said second principal face 37 of beam splitter 35ᵢ and with a 45° angle relative to the plane 19 of said splitter, so that these radiations are reflected in the direction of the rod 34ₓ₊₁ of the next assembly.

In this embodiment, the fifth and sixth pumping means 38 and 39 are identical to the pumping means 1 in FIG. 3, that is, they consist of a generator 10 and a diode or a strip of diodes or a two-dimensional matrix of diodes 11. De plus, the fifth and sixth pumping laser radiations are identical, respectively, to said first and second pumping laser radiations. In any event, however, the generator may be common to the pumping means 1, the third and fourth pumping means 16 and 17 and the fifth and sixth pumping means 38 and 39.

A high-energy laser source may be obtained by means of such a device and, thanks to the appearance of a laser radiation window generated by each rod upon the start of the emission of the pumping laser radiation windows, the operation in Q-switched mode does not require the use of supplementary oscillation detection means, as in the case of prior art.

Obviously, many modifications may be made to the embodiment described above without departing from the framework of the invention. Thus, the first and second, third and fourth and/or fifth and sixth pumping means may emit respective radiations of different lengths, distributed within the absorption spectrum of the active ion used in the crystal, and the pumping means may include diodes or any other continuous or pulsed laser source.

In addition, the trigger may be active or passive, whereas the cooling liquid may be water or any other fluid with adequate thermal properties.

Moreover, the laser crystal may especially consist of one of the following crystals: YAG, YALO, YVO₄ or YLF doped with thulium or with holmium.

1-13. (canceled)

14. Process for the emission of low frequency pulsed infrared laser radiation generated by at least one holmium, thulium or erbium doped laser crystal which is located in a cavity consisting of a first and a second mirrors and pumped by pumping means, wherein said process comprises a first step consisting in generating a pumping laser radiation with an intensity of J_{c} which is capable of bringing the crystal at least to the laser emission threshold and a second step consisting in generating a second pumping laser radiation with an intensity of Jₚ in the form of a step, whereby said second radiation is superimposed, at least in part, on said first radiation or immediately succeeds it, and whereby the intensity Jₚ, in the latter case, is greater than the intensity J_{c} of said first radiation.

15. Laser emission process according to claim 14, wherein
$$\frac{{J}_{p}}{{J}_{c}} > 10.$$

16. Process according to claim 15, wherein the second step consists in superimposing said first and second pumping laser radiations having different wavelengths.

17. Laser source capable of generating low frequency infrared laser pulses, consisting of pumping means capable of pumping a holmium, thulium or erbium doped laser crystal which is located in a cavity delimited by a first and a second mirror, the pumping means being capable of generating a pumping laser radiation with an intensity of Jₚ in the form of a step, wherein the pumping means are capable of generating a first pumping laser radiation with an intensity of J_{c} which is capable of bringing the crystal at least to the laser emission threshold and the second stage consisting of generating a second pumping laser radiation with an intensity of Jₚ in the form of a step, whereby said second radiation is superimposed, at least in part, on said first radiation or immediately succeeds it, and whereby the intensity Jₚ, in the latter case, is greater than the intensity J_{c} of said first radiation.

18. Laser source according to claim 17, wherein the pumping means includes first auxiliary pumping means capable of generating the first radiation and second principal pumping means capable of generating said second pumping radiation in the form of a step.

19. Laser source according to claim 17, wherein the first pumping means are capable of generating a first continuous pumping laser radiation.

20. Laser source according to claim 17, wherein the pumping means include at least one laser diode.

21. Laser source according to claim 17, wherein the first and second pumping means are capable of generating first and second pumping laser radiations with different wavelengths.

22. Laser source according to claim 14, wherein the crystal includes at least three faces and wherein the pumping means include first and second pumping means capable of generating said first and second pumping radiations in the direction of a first face of said crystal and at least third pumping means capable of generating at least a third pumping radiation in the direction of the second face of said crystal.

23. Laser source according to claim 22, wherein a beam splitter including at least one principal face covered by a coating which reflects at the wavelength or wavelengths of the pumping radiations and is transparent for a polarization of the laser radiation generated by the crystal, is located in the interior of the cavity and is capable of directing said at least third laser radiation in the direction of said second face of the crystal.

24. Laser source according to claim 17, wherein the cavity includes a plurality of laser crystals, each crystal having, for example, the shape of a rod.

25. Laser source according to claim 23, wherein the cavity includes a plurality of ensembles composed of a crystal and a beam splitter, whereby the latter includes at least one principal face covered by a reflective coating which reflects at the wavelength or wavelengths of the pumping radiations and is transparent for a polarization of the laser radiation generated by the crystal.

26. Laser source according to claim 17, wherein the crystal consists of one of the following crystals: YAG, YALO, YVO₄ or YLF doped with thulium or holmium.
